(19) United States
(12) Patent Application Publication
(10) Pub. No.: US 2026/0152957 A1
(43) Pub. Date: Jun. 4, 2026

(54) Printing System and 3D Printing Process

(71) Applicant: Putzmeister Engineering GmbH, Aichtal (DE)

(72) Inventors: Robin DEGEN, Darmstadt (DE); Knut KASTEN, Ostfildern (DE); Benedikt PAWISA, Wernau (DE)

(21) Appl. No.: 19/122,305

(22) PCT Filed: Sep. 21, 2023
(86) PCT No.: PCT/EP2023/076053

§ 371 Date: Apr. 18, 2025

(30) Foreign Application Priority Data
Oct. 21, 2022 (DE) 10 2022 211 175.3

(51) Int. Cl. E04G 21/04; B29C 64/232; B29C 64/336; B33Y 10/00; B33Y 30/00; B33Y 80/00

(52) U.S. Cl. CPC E04G 21/0463; B29C 64/232; B29C 64/336; B33Y 10/00; B33Y 30/00; B33Y 80/00

(57) ABSTRACT

A printing system for automatically producing a building part via 3D printing on a print bed, includes: a first discharge device for forming a strand of construction material at a first discharge portion of the first discharge device, wherein the first discharge device can be moved relative to the print bed in order to automatically arrange the construction material on the print bed in at least one construction material layer of the building part; and at least one second discharge device for discharging at least one functional material, different from the construction material, at a second discharge portion of the second discharge device, wherein the second discharge device can be moved relative to the print bed in order to automatically coat the at least one construction material layer, at least in portions, with the functional material in order to form at least one functional material layer of the building part. The first discharge portion and the second discharge portion are formed separately.

### FIELD OF ART

The invention relates to a printing system for automatically producing a building part by means of 3D printing on a print bed. The invention also relates to a 3D printing method for automatically producing a building part by means of such a printing system.

### TASK AND SOLUTION

It is a task of the invention to provide a printing system for automatically producing a building part by means of 3D printing on a print bed and a 3D printing method for automatically producing a building part by means of such a printing system, which have improved properties.

This task is solved by the objects of the independent patent claims. Preferred embodiments are the object of the dependent claims.

A printing system according to the invention is used to automatically produce a building part by means of 3D printing on a print bed. In particular, the print bed is not a component of the printing system. The printing system may comprise a base that is set up to be arranged in such a way that it is fixed to the print bed. In this connection, the base may alternatively be used as a reference for any moveability relative to the print bed. The print bed may be the floor of a production hall or the subfloor of a building site. Alternatively, the print bed may be formed by a platform of the printing system. The printing system comprises a first discharge device, which serves to form a strand of construction material at a first discharge portion of the first discharge device. The first discharge device can be moved relative to the print bed in order to automatically arranging the construction material in at least one construction material layer of the building part on the print bed. In particular, the construction material may be automatically deposited on the print bed by means of the first discharge device. In this way, a stack with several construction material layers can be created, which are arranged one above the other along a vertical line. Neighboring construction material layers in the stack are preferably bonded to each other with a material bond and/or uniform material, so that the stack can form a coherent layered body of the building part.

The printing system comprises a second discharge device for discharging at least one functional material that is different from the construction material. The functional material can be discharged at a second discharge portion of the second discharge device. The second discharge device can be moved relative to the print bed in order to automatically coat at least one construction material layer, at least in portions, with the functional material, in order to form at least one functional material layer of the building part. In particular, the construction material layer can be coated with functional material in a strip-like manner. At least construction material layer can be coated with functional material along a meandering path in order to form at least one flat area of the functional material layer. The first discharge portion and the second discharge portion are configured as separate from one another. The functional material and the construction material can thus be applied separately from one another, in particular at different points in the printing system. In this way, a mutual contamination of the construction material with functional material and vice versa can advantageously be avoided. In addition, the printing system advantageously makes it possible to at least partially or even completely eliminate the need for manual post-processing of at least one construction material layer by manually coating it with functional material. In this respect, the inaccuracies associated with such manual post-processing can be at least partially or even completely avoided. Conversely, the printing system enables particularly precise and reliable production of the building part with at least one construction material layer and at least one layer of functional material.

The building part may be a composite building part having at least one construction material layer and at least one layer of functional material. Such a composite building part allows advantageous properties of both the construction material and the functional material to be combined in one and the same building part. For the construction material, such advantageous properties may include, for example, thixotropy, which enables the discharged construction material to retain its shape without formwork even before hardening, as well as hardenability after discharge in order to preserve the 3D-printed shape. In addition, the hardened construction material can make a major contribution to the strength of the composite building part. For the functional material, such advantageous properties may include, for example, low thermal and/or acoustic conductivity, a smooth or textured surface, the surface wettability, an adhesive and/or cohesive effect, a color, or a toughness.

The construction material is preferably a thick material. The thick material may be a pulp-like mixture of different materials. The thick material may be mortar, cement, screed, or concrete, each in a mixable and/or pumpable state. In the mixable and/or conveyable state, the thick material has not yet hardened or set.

The term “configured” can be used synonymously for the term formed.

The term “includes” or has” can be used synonymously for the term “comprises”.

“Control” in this context may mean “control” and/or “regulate”.

“Discharge” can in this context denote the process in which a material leaves a discharge device. In contrast to such a discharge, the term “discharge” can denote a putting of the material into contact with a subfloor. As a result of the discharge, the previously removed material can adhere to the subfloor and be distributed there if necessary. Between discharge and application, the material can be transported without conduction through an external environment of the printing system in order to overcome a free distance between a discharge location and an application location.

The term “discharge” can be used synonymously with the term “extrusion”, at least in connection with the construction material. The first discharge portion can be a nozzle opening or an extrusion die.

In an embodiment of the invention, the printing system has a movement unit which can be moved relative to the print bed in at least three degrees of freedom. The discharge devices are arranged on the movement unit in such a way that the discharge devices can be automatically moved together with the movement unit relative the print bed. The first discharge portion can be automatically moved or cannot be moved relative to the movement unit. Alternatively or additionally, the second discharge portion can be automatically moved or cannot be moved relative to the movement unit. Accordingly, the two discharge portions can be automatically moved or cannot be moved relative to each other. This is advantageous for the production of particularly complex-shaped building parts.

In a further embodiment of the invention, the first discharge device and the second discharge device are designed differently. In particular, the discharge devices differ in the shape, in particular a cross-section, of a discharge opening of the respective discharge device forming the respective discharge device. In particular, the discharge devices are alternatively or additionally different in an amount of a cross-sectional area of a discharge opening of the respective discharge portion forming the respective discharge section, in particular wherein the cross-sectional area of the discharge opening of the first discharge device is at least 2 times to 50,000 times, in particular 10 times to 20,000 times, as large in terms of amount as the cross-sectional area of the discharge opening of the second discharge device. Depending on the construction material and/or functional material used, the discharge devices can thus be designed for particularly good, i.e. precise, and/or reliable and/or fast discharge.

In a further embodiment of the invention, at least one functional material is selected from the following group: insulating material for thermal and/or acoustic insulation of the building part, plastering material for plastering the building part, bonding agent for increasing adhesion, in particular for at least one further construction material and/or at least one further construction material layer and/or at least one further construction material layer, adhesive for bonding an additional component to the building part, colorant, in particular bonded in a bonding agent, for coloring the building part, and crack inhibitor, in particular in the form of water or an evaporation-inhibiting material, for inhibiting the formation of cracks in the building part, in particular in at least one construction material layer. At least one such functional material can be used. Several of the aforementioned functional materials can be used, which can be arranged in different functional layers. If an insulating material is used as the functional material, it is advantageous to dispense with manual insulation of the building part. If an adhesion promoter material is used as the functional material, a particularly robust bond can be achieved between adjacent construction material layers stacked on top of each other. If the bonding agent is used, a particularly robust bond can also be achieved between another functional material and at least one construction material layer. If an adhesive is used as the functional material, an additional component, for example in the form of a window element or door element, can be attached to the building part, in particular without manually applying the adhesive. If a colorant is used as the functional material, there is no need to manually paint the building part. If a crack-inhibiting material is used as the functional material, the result is a particularly robust building part with a particularly low tendency to crack. It is contemplated that different functional materials are discharged one after the other in serial passes by means of one and the same second discharge device. Alternatively or additionally, several second discharge devices can be provided, each of which is designed for the simultaneous, i.e. parallel, or serial discharge of one or more functional materials.

In a further embodiment of the invention, the printing system comprises a print head that can be moved relative to the print bed. The print head comprises the first discharge device and-alternatively or additionally-the second discharge device. Alternatively, the printing system comprises a separate print head for each discharge device. Such a print head enables the construction material and/or the functional material to be discharged in a particularly accurate position, so that the construction material and/or the functional material can be applied with particular precision at a target position.

In a further embodiment of the invention, the printing system has a positioning device for the controlled positioning of the first discharge device and/or the second discharge device relative to the print bed. The positioning system can comprise a measuring system and a driven adjustment device that interact with each other. By means of the positioning device, the discharge devices can be moved relative to the print bed as a function of, in particular digital, construction data in order to produce the building part as a function of the construction data.

In a further embodiment of the invention, the printing system, in particular as a movement unit, has a controllable robot arm. The robot arm can be called a manipulator. The robot arm has a robot section that can be adjusted relative to the print bed in at least three, in particular at least four, degrees of freedom. The first discharge device and the second discharge device are arranged, in particular attached, to the robot section. In particular, the robot arm has several arm elements that are articulated relative to one another about associated articulation axes, i.e. in particular pivotable, and-alternatively or additionally-rotatable transversely to the articulation axes. Such a robot arm enables the production of geometrically particularly complex shaped building parts, i.e. in particular building parts with a wide variety of different shapes. In particular, such a robot arm makes it possible to apply functional material to all surface areas of at least one construction material layer that are not in contact, at least in portions, with the print bed.

In a further embodiment of the invention, the second discharge device has a spraying device for discharging at least one functional material in the form of a spray jet. Alternatively or additionally, the second discharge device comprises a foaming device for discharging at least one functional material in the form of foam. Alternatively or additionally, the second discharge device comprises an application device, in particular a brush and/or a roller, for applying at least one functional material discharged by means of the second discharge device to at least one construction material layer. The foaming device can advantageously be used to discharge a functional material that can be foamed or is self-foaming as a result of a chemical reaction at atmospheric pressure and/or in contact with air. Such a self-foaming functional material can be, for example, an insulating material, in particular comprising polyurethane. By means of the application device, the functional material can be distributed particularly evenly on at least one construction material layer.

In a further embodiment of the invention, the printing system has a pump device for conveying at least one flowable, in particular liquid, functional material. In particular, the pump device is fed from a stock of flowable functional material. Preferably, the second discharge device can be supplied with a flowable functional material by means of the pump device. This allows a reliable and preferably even discharge of the functional material. The term “extrude” can be used synonymously in connection with the flowable functional material for the term extrusion. The second discharge portion can be a nozzle opening or an extrusion die.

In a further embodiment of the invention, the printing system has a transport device for transporting at least one solid functional material, in particular in the form of a granulate or an elongated or flat semi-finished product. The transport system can be pneumatic and/or hydraulic and/or mechanical, in particular drivable. In particular, the transport device is fed from a supply of solid functional material. In particular, the second discharge device can be supplied with solid functional material by means of the transport device. The use of a solid functional material has the advantage that there is no hardening time for hardening the layer of functional material produced with the solid functional material.

In a further embodiment of the invention, the printing system has a connecting device, especially a connecting line. The connecting device is connected to the second discharge device so that at least one functional material of the second discharge device can be fed by means of the connecting device. The connecting device runs along at least a portion of a robot arm, in particular manipulator, of the printing system. The connecting device makes it advantageously possible to arrange a supply and/or the pumping device for the functional material at a distance from the discharge device. The supply and/or the pump device may be arranged in a print bed fixed so that the supply and/or the pump device does not have to be moved relative to the print bed.

In a further embodiment of the invention, the printing system has a sensor device for monitoring the coating of at least one construction material layer with at least one functional material. By means of the sensor device, a layer thickness of the functional material layer can be monitored. The sensor device can be used to monitor an extension, i.e. layer width and/or layer length, of the functional material layer. Alternatively or additionally, the printing system has a control unit, in particular an electronic one. The control unit is set up to control the adjustment of the first discharge device and-alternatively or additionally-the second discharge device. The control unit is also set up to control the discharge of construction material and-alternatively or additionally-of functional material. In particular, the control unit is connected to the sensor device in a data-transmitting manner. The control unit advantageously enables a coordinated adjustment of the discharge devices as well as a coordinated discharge of construction material and functional material.

A 3D printing method according to the invention is used to automatically produce a building part by means of a printing system according to the invention as described above. The advantages of the printing system according to the invention described above therefore also apply to the 3D printing method according to the invention. The method has a step a), according to which construction material is automatically arranged in at least one construction material layer on the print bed. The 3D printing method also comprises a step b), according to which, in particular at least in portions, an automatic coating of at least one construction material layer with functional material takes place, in particular where the coating is carried out in a strip-like manner. The arrangement of the building material according to step a) and-alternatively or additionally-the automatic coating according to step b) can be carried out as a function of, in particular digital, construction data.

In an embodiment of the 3D printing method, when step b) is carried out, an essentially horizontally oriented top side of at least one construction material layer and alternatively or additionally-at least one flank side of at least one construction material layer oriented at an angle, in particular vertically, to the top side are coated in particular at least in portions, with functional material. In this way, particularly complex geometrically shaped building components can be produced.

In a further embodiment of the 3D printing method, step b) is carried out after step a), in particular after a predetermined number of construction material layers of the building part have been arranged. This offers the advantage that the construction material in the construction material layers can set at least partially, especially on the surface, or completely before the functional material layer is applied. The functional material can be applied wet-on-dry to at least one construction material layer. Alternatively, step b) is carried out at the same time as step a), in particular with the removal of the construction material and the functional material is carried out with a local offset to one another. Carrying out steps a) and b) at the same time enables the building part to be produced in a particularly short production time. In addition, it can be conducive to adhesion of the functional material layer if the construction material of the construction material layer is not yet or not yet fully hardened. The functional material can be applied wet-on-wet to at least one construction material layer.

Further advantages and features of the invention are apparent from the claims and from the following description of a preferred embodiment of the invention, which is shown in the drawing. Here, identical reference signs refer to identical or similar or functionally identical components.

It is understood that the features mentioned above and those to be explained below can be used not only in the combination indicated in each case, but also in other combinations or in a stand-alone position, without departing from the scope of the present invention.

### BRIEF DESCRIPTION OF THE DRAWING

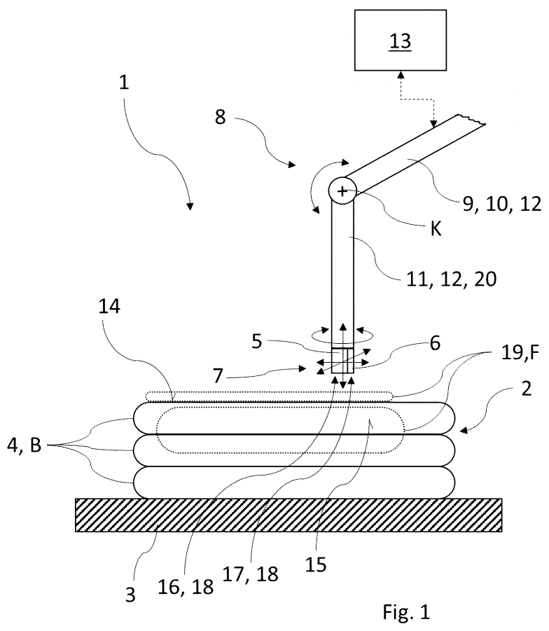

The single FIG. 1 is a schematic side view of an embodiment of a printing system according to the invention for producing a building part by means of 3D printing after carrying out a 3D printing method according to the invention.

### DETAILED DESCRIPTION OF THE DRAWING

A printing system 1 is set up for the automatic production of a building part 2 by means of 3D printing on a print bed 3. In this context, 3D printing can be understood as additive manufacturing. The print bed 3 is not a component of the printing system 1. The print bed 3 can be a level that is present, for example, on a floor of a production hall or on a subfloor of a building site. The printing system 1 can comprise a base that can be arranged on the print bed 3 in a print bed-proof manner and is arranged accordingly in the present case.

The printing system 1 comprises a first discharge device 5. The first discharge device 5 serves to form a strand of construction material B at a first discharge portion 16 of the first discharge device 5. At the first discharge portion 16, the strand of construction material B can leave the discharge device 5 when the construction material is discharged by means of the discharge device 5. The first discharge portion 16 can, for example, be designed as a nozzle opening through which the strand of construction material can be extruded. The first discharge device 5 can be moved relative to the print bed 3. The first discharge device 5 can be moved relative to the print bed 3 in such a way that the construction material B can be automatically arranged on the print bed 3 in at least one construction material layer 4 of the building part 2. For example, the construction material B can be automatically deposited on the print bed in at least one construction material layer 4 by moving the first discharge device 5 relative to the print bed 3. The first discharge device 5 can be adjusted relative to the printing bed 3 in such a way that the construction material B can be automatically arranged on the printing bed 3 in at least one construction material layer 4 of the building component 2.

The printing system 1 also comprises at least one second discharge device 6. The second discharge device 6 is used to discharge at least one functional material F, which is different from the construction material B, at a second discharge portion 17 of the second discharge device 6. When the functional material F is discharged, the functional material F can leave the second discharge device 6 at the second discharge portion 17. The second discharge portion 17 can, for example, be designed as a nozzle opening through which the functional material F can be discharged. The second discharge device 6 can be moved relative to the print bed 3 in order to automatically coat at least one construction material layer 4, at least in portions, with the functional material F. As a result of this coating, at least one functional material layer 19 of the building part 2 can be formed. For example, the second discharge device 6 can be moved relative to the print bed 3 in such a way that the construction material layer 4 can be coated with functional material F in a strip-like manner. The first discharge portion 16 and the second discharge portion 17 are formed separately from one another. Each of the discharge devices 5, 6 thus has its own discharge portion 16, 17. In other words, the strand of construction material B can be discharged at a different location than the functional material F. The first and second discharge portions 16, 17 can be arranged at a distance from one another, in particular at a constant or variable distance from one another.

In the present case, the printing system 1 has a movement unit 20. The movement unit 20 can be moved relative to the print bed 3 in at least three degrees of freedom. In the illustration in FIG. 1, the degrees of freedom are shown using double arrows. In this case, the movement unit 20 can be moved in five degrees of freedom. Three of these degrees of freedom are defined by three spatial axes oriented perpendicular to each other. One of the spatial axes runs vertically, while the other two spatial axes run perpendicular to each other and horizontally. The vertical spatial axis, which is located in the plane of the illustration in FIG. 1, can be referred to as the z-axis. The horizontal spatial axis running in the plane of the illustration according to FIG. 1 can be referred to as the y-axis. The spatial axis shown at an angle in the illustration according to FIG. 1 can run perpendicular to the imaging plane and be referred to as the x-axis. The x-, y- and z-axes can form a three-dimensional Cartesian coordinate system. In the present case, the movement unit 20 can be rotated about the vertical spatial axis relative to the print bed 3. In addition, the movement unit 20 can be rotated or pivoted relative to the print bed 3 about a horizontal articulation axis K. This results in at least five degrees of freedom of movement of the movement unit 20 relative to the print bed 3.

In order to be able to apply the functional material layer 19 both to a top side 14 of at least one construction material layer 4 and to a lateral flank side 15 of at least one construction material layer 4, it may be expedient if the movement unit 20 can be moved in at least four degrees of freedom. For example, the movement unit 20 can usefully be moved along a straight line at least along the three spatial axes and rotatable relative to the print bed 3 at least about the vertical spatial axis.

For example, the first discharge device 5 and the second discharge device 6 are designed differently. The discharge devices 5, 6 can differ in the shape of a discharge opening 18 of the respective discharge device 5, 6 forming the respective discharge portion 16, 17. Each discharge opening 18 can have a cross-section. The shape of the cross-section of the discharge openings 18 can be different. The cross-section can be aligned perpendicular to a discharge direction of the respective discharge device 5, 6, along which the discharge can take place in each case. For example, the discharge opening 18 of the first discharge device 5 can have a square, for example rectangular, shape. The rectangular shape can be square or non-square. “Rectangular” can mean ‘essentially rectangular’. An “essentially rectangular” shape may, for example, have rounded or chamfered corners. Other essentially rectangular shapes, for example trapezoidal or oblique parallelogram-shaped, are also possible. The discharge opening 18 of the second discharge device 6 can have a rounded or circular shape. Such a rounded or circular shape can be circular or elliptical. It is understood that other shapes are also contemplated for the cross-sections of both discharge openings 18, for example triangular shapes or other polygonal shapes.

Other rounded shapes are also contemplated, particularly in the form of a free-form or unrounded shape.

Alternatively or additionally, the first and the second discharge device 5, 6 differ in an amount of a cross-sectional area of the discharge opening 18 forming the respective discharge portion 16, 17. The cross-sectional area can be oriented perpendicular to the discharge direction of the respective discharge device 5, 6. For example, the amount of the cross-sectional area of the first discharge portion 16—as in the present case—is greater than the amount of the cross-sectional area of the second discharge portion 17. The cross-sectional area of the discharge opening 18 of the first discharge device 5 can be at least 2 times to 50,000 times as large in terms of amount as the cross-sectional area of the discharge opening 18 of the second discharge device 6. The cross-sectional area of the discharge opening 18 of the first discharge device 5 can be 10 times to 20,000 times as large as the cross-sectional area of the discharge opening 18 of the second discharge device 6. The cross-sectional area of the discharge opening 18 of the first discharge device 5 can be larger by a factor of 20 to 10,000, in particular 50 to 1,000, than the cross-sectional area of the discharge opening 18 of the second discharge device 6.

Various materials can be considered as the functional material F, which can be used alone or in combination with one another in order to arrange at least one or more functional material layers 19 on at least one construction material layer 4. Each functional material layer 19 can be attached to at least one construction material layer 4 or a stack of construction material layers 4 in portions. It is understood that different functional material layers 19 may be present in different areas, each of which is formed with different or the same functional materials F. The several functional layers 19 can overlap each other, touch each other like butt joints or be arranged at a distance from each other.

The functional material F can, for example, be an insulating material for thermal and/or acoustic insulation of the building part 2. The functional material F can be a plastering material for plastering the building part 2. The functional material F can be an adhesion promoter to increase adhesion, for example for at least one further functional material F and alternatively or additionally-for at least one further construction material layer 4. The functional material F can be an adhesive for bonding an additional component to the building part 2. Such a component can be, for example, a window or door unit for a structure comprising the building part 2. The functional material F can also be a colorant for coloring the building part 2. The colorant can be bonded in a bonding agent. By means of the colorant, at least one construction material layer 4 can be provided with a functional material layer 19 as a coating of the building part 2. The functional material can also be a crack inhibitor for inhibiting the formation of cracks in the building part 2, in particular in at least one construction material layer 4. The crack inhibitor can be in the form of an evaporation-inhibiting material. Such an evaporation-inhibiting material can serve to inhibit the evaporation of liquid present in the construction material B. For example, the evaporation-inhibiting material may be impermeable to gas. Under standard conditions (STP conditions), the evaporation-inhibiting material may be essentially in the liquid and/or solid phase and may, for example, have little or no tendency to evaporate and/or outgas. For example, a paraffin-based solution can be used as the evaporation-inhibiting material.

It is contemplated that different functional materials F are discharged and/or applied one after the other in serial passes by means of one and the same second discharge device 6. Alternatively or additionally, it is contemplated that several second discharge devices 6 are present, each of which is designed for the simultaneous, i.e. simultaneous, or serial discharge and/or application of a separate functional material F. A separate functional material layer 19 can then be produced by means of each of these several second discharge devices 6.

In the present case, the printing system 1 comprises a print head 7 that can be moved relative to the print bed 3. The print head 7 has the first discharge device 5 and the second discharge device 6. Alternatively, only one of the discharge devices 5, 6 can be included in the print head 7. The printing system 1 can comprise a separate print head 7 for each discharge device 5, 6. For example, the printing system 1 comprises a positioning device 8. The positioning device 8 is used for controlled positioning of the first discharge device 5 and alternatively or additionally-the second discharge device 6 relative to the print bed 3. The positioning device 8 can have a measuring system for detecting an instantaneous position of the discharge devices 5, 6 relative to the print bed 3 and an adjusting device, in particular an electrically driven adjusting device, by means of which the discharge devices 5, 6 can be moved relative to the print bed 3. The measuring system and the adjusting device can interact with each other in order to achieve reliable positioning of at least one construction material layer 4 and/or at least one layer of functional material 19.

In the present case, the printing system 1 has a controllable robot arm 9. In this context, “control” can mean “control” and/or “regulate”. The robotic arm 9 can be referred to as a manipulator 10. The robot arm 9 has a robot portion 11 that can be moved relative to the print bed 3 in at least three, in particular at least four, degrees of freedom. In the embodiment shown, the moveable robot portion 11 acts as a movement unit 20. In this respect, reference is made to the mobility of the movement unit 20 already explained above with regard to the mobility of the robot portion 11 relative to the print bed 3. The first discharge device 5 and the second discharge device 6 are arranged on the robot portion 11. The first discharge device 5 and the second discharge device 6 can be attached to the robot portion 11. The robot arm 9 can have several arm elements 12. The arm elements 12 can be articulated relative to one another about associated axes of articulation K and—alternatively or additionally—can be rotated transversely to the axes of articulation K. The axes of articulation K can be joint axes of articulation devices which, for example, connect two arm elements 12 to each other so that they can move relative to each other. For example, such a joint device can be a hinge joint with a single axis of articulation K. It is understood that instead of hinge joints with only a single axis of articulation K, other types of joint can also be used to connect two adjacent arm elements 12 to one another so that they can move relative to one another. For example, two adjacent arm elements 12 can be connected to each other in a ball-and-socket joint. Alternatively or additionally, two adjacent arm elements 12 of the robot arm 10 can be connected to each other by a gimbal.

The second discharge device 6 comprises, for example, a spraying device for discharging at least one functional material F in the form of a spray jet. The spraying device can comprise a spray nozzle. The functional material F can be atomized in the spray jet. Alternatively or additionally, the second discharge device 6 comprises, for example, a foaming device for discharging at least one functional material F in foam form. The foaming device can comprise a foaming nozzle that can add a gas to the functional material F for foaming. Alternatively or additionally, it is contemplated that a gas for foaming the functional material F is produced as a result of a cross-linking reaction of polymeric or monomeric components of the functional material F and therefore does not have to be introduced from the outside by means of the foaming device, for example.

Alternatively or additionally, the second discharge device 6 comprises, for example, an application device comprising a brush and-alternatively or additionally-a roller. The application device is used to apply at least one functional material F discharged by the second discharge device 6 to at least one construction material layer 4. “Discharging” can refer to the process in which the functional material F leaves the discharge device 5, 6. In contrast, “applying” can refer to the process that corresponds to bringing the material into contact with a substrate. In the present case, the substrate can be at least one construction material layer 4 and the applied material can be, for example, the functional material F. As a result of the application, the applied material can adhere to the substrate and possibly be distributed there.

The printing system 1 comprises, for example, a pumping device for conveying at least one flowable, in particular liquid, functional material F. The pumping device can be fed from a supply of flowable functional material F, wherein the second discharge device 6 can be supplied with the flowable functional material F by means of the pumping device. Alternatively or additionally, the printing system 1 can have a transport device, for example pneumatic and/or hydraulic and/or mechanical, for transporting at least one solid functional material F. The solid functional material F is present in a solid aggregate state. The solid functional material F can, for example, be in the form of granulate or an elongated or flat semi-finished product, in particular in wire or rod or film or sheet form. The transport device can be fed from a supply of solid functional material F. The second discharge device 6 can be supplied with solid functional material F by means of the transport device. The supply of functional material F can be arranged to be print bed-resistant. In the case of a pneumatic transport device, the functional material F can be transported in a gas or liquid flow by means of the transport device. A mechanical transport device can be in the form of a belt conveyor, a bucket conveyor, a screw conveyor, or a bucket chain, for example.

The printing system 1 has, for example, a connecting device, in particular in the form of a connecting line. The connecting device is connected to the second discharge device 6, so that at least one functional material F can be fed to the second discharge device 6 by means of the connecting device. The connecting device runs, for example, at least in portions, along the robot arm 9, in particular the manipulator 10, of the printing system 1. The connecting device or connecting line can run along the entire length of the robot arm 9.

A corresponding connecting device can also be provided for the construction material B, which connects the first discharge device 5 with a supply for storing the construction material B. The connecting device for the construction material B can run, at least in portions, along the robot arm 9. The connecting device or connecting line for the construction material B can run along the entire length of the robot arm 9. The connecting device for the construction material B can connect the first discharge device 5 to a construction material pumping unit.

The construction material pump unit can comprise delivery cylinders with variable-volume delivery chambers. The delivery cylinders can each comprise a moveable delivery piston to change the volumes of the delivery chambers, in particular in opposite directions. The construction material pumping unit can also comprise an S-shaped S-tube, which is connected at one end in a fluid-conducting manner to a discharge nozzle acting as a pump outlet. The S-tube can be arranged in a storage chamber that can be filled with construction material from above for storing construction material. The S-tube can be rotatably mounted at one end on the discharge nozzle within the supply chamber. The variable-volume conveying chambers can open into the supply chamber. The S-tube can be pivoted in the supply chamber relative to the delivery chambers in such a way that it can be connected to one of the delivery chambers in an alternating fluid-conducting manner. In this way, construction material in the storage chamber can be alternately sucked in by means of the conveying chambers and pumped out via the conveying chambers through the S-tube via the discharge nozzle due to the backlash of the pivoting of the S-tube and a change in volume of the conveying chambers. An agitator can be arranged in the supply chamber of the construction material pump unit. Downstream of the thick matter pumping unit and upstream of the first discharge device 5, a buffer tank for the intermediate storage of construction material B and/or an additional conveying device, for example in the form of an eccentric screw pump, can be arranged in the connecting device or connecting line for the construction material B to supply the first discharge device 5 with construction material B.

The printing system 1 comprises a sensor device, for example. This sensor device can be used to monitor the coating of at least one construction material layer 4 with at least one functional material F. Alternatively or additionally, the printing system can comprise a control unit, in particular an electronic control unit 13. The control unit 13 can be set up to control the adjustment of the first discharge device 5 and-alternatively or additionally-the second discharge device 6. Alternatively or additionally, the control unit 13 can be designed to control the discharge of construction material B and/or functional material F. The electronic control unit 13 can be connected to the sensor device in a data-transmitting manner.

The printing system 1 is set up to carry out a 3D printing method according to the invention. The 3D printing method is used to automatically produce the building part 2 by means of the printing system 1. The 3D printing method comprises a step a). According to step a), construction material B is arranged in at least one construction material layer 4 on the print bed 3.

The 3D printing method also comprises a step b). According to step b), at least one construction material layer 4 is automatically coated with functional material F. In particular, at least one layer 4 of construction material is coated, at least in portions, with the functional material F. The coating of the construction material layer 4 with functional material F can be in a strip-like manner. The arrangement of construction material B according to step a) can be carried out as a function of, in particular digital, construction data. The construction data can, for example, be available as a digital SD model. The SD model can be a layer model.

For example, when carrying out step b), an essentially horizontally oriented top side 14 of at least one construction material layer 4 is coated with functional material F. Alternatively or additionally, a flank side 15 of at least one layer of construction material 4 that is oriented at an angle, in particular vertically, to the top side 14 is coated with functional material F. The top side 14 can be coated with functional material F in portions or over the entire surface. The flank side 15 can be coated with functional material F in portions or over the entire surface. A seam can be formed between two adjacent construction material layers 4. This seam can be overlapped or covered by the functional material layer 19. There may be horizontal and/or vertical seams that are covered by the functional material layer 19. A functional material layer 19 may be present in the seam itself, i.e. between two adjacent construction material layers 4. In principle, it is also contemplated that a functional material layer 19 is arranged between the print bed 3 and a bottom construction material layer 4. In other words, to connect the bottom construction material layer 4 to the print bed 3, a functional material layer 19 can be placed on the print bed 3, on which the construction material B can then be deposited in the bottom construction material layer 4.

For example, step b) is carried out after step a). Step b) can be carried out when a predetermined number of construction material layers 4 of the building part 2 have been arranged on the print bed 3. Alternatively, step b) is carried out at the same time as step a). In this case, the construction material B and the functional material F can be applied with a local offset to each other. The functional material F can therefore already be discharged when a construction material layer 4 has not yet been completely produced.

A height of at least one construction material layer 4, in particular along a direction of gravity, can be at least 4 cm. The height can, for example, be 4 cm to 10 cm. A horizontal width of the construction material layer 4, in particular perpendicular to the direction of gravity and perpendicular to a direction of adjustment of the first discharge device 5, can be at least 10 cm. The width can be between 10 cm and 40 cm. A layer thickness of the functional material layer 19 can be less than the height of the construction material layer 4. A layer width of the functional material layer 19 can be less than the width of the construction material layer 4. The layer width of the functional material layer 19 can be 5 times to 100 times smaller than the width of the construction material layer 4. In the case in which an insulating material is used as functional material F, however, the functional material layer 19 can also have a greater layer thickness than the height of the construction material layer 4 and/or a greater layer width than the width of the construction material layer 4. If insulating material is used as the functional material F, the layer width of the functional material layer 19 can be at least twice as large, for example 5 times as large, as the width of the construction material layer 4. The layer width of the functional material layer 19 can be at least as large as the height of the construction material layer 4, in particular if the functional material layer 19 is applied to the flank side 15. If the functional material layer 19 is attached to the top side 14, the layer width of the functional material layer 19 can be 10 times smaller than the height of the construction material layer 4. The layer thickness extends, for example, perpendicular to a surface of the construction material layer 4 coated with the functional layer 19. The layer width extends, for example, perpendicular to the layer thickness. The layer width can extend perpendicular to an adjustment direction of the second discharge device 6.

1-15. (canceled)

16. A printing system for automatically producing a building part via 3D printing on a print bed, the printing system comprising:
a first discharge device that forms a strand of construction material at a first discharge portion of the first discharge device, wherein the first discharge device is movable relative to the print bed in order to automatically arrange the construction material in at least one construction material layer of the building part on the print bed; and
at least one second discharge device that discharges at least one functional material, different from the construction material, at a second discharge portion of the second discharge device, wherein the second discharge device is movable relative to the print bed in order to automatically coat at least one construction material layer, at least in portions, with the functional material, in order to form at least one functional material layer of the building part,
wherein the first discharge portion and the second discharge portion are formed separately.

17. The printing system according to claim 16, further comprising:
a movement unit which is movable relative to the print bed in at least three degrees of freedom,
wherein the first and second discharge devices are arranged on the movement unit, so that the discharge devices are movable together with the movement unit relative to the print bed.

18. The printing system according to claim 17, wherein
the first discharge portion is movable or cannot be moved relative to the movement unit, and/or
the second discharge portion is movable or cannot be moved relative to the movement unit.

19. The printing system according to claim 16, wherein
the first discharge device and the second discharge device are of different design.

20. The printing system according to claim 19, wherein the first and second discharge devices are different in:
a contouring of a discharge opening of the respective discharge device forming the respective discharge portion, and/or
an amount of a cross-sectional area of a discharge opening of the respective discharge device forming the respective discharge portion.

21. The printing system according to claim 20, wherein the cross-sectional area of the discharge opening of the first discharge device is at least 2 times to 50,000 times, or 10 times to 20,000 times, as large as the cross-sectional area of the discharge opening of the second discharge device.

22. The printing system according to claim 16, wherein at least one functional material is selected from a group consisting essentially of:
insulating material for a thermal and/or acoustic insulation of the building part,
plastering material for plastering the building part,
bonding agent for increasing adhesion,
adhesive for bonding an additional component to the building part,
colorant for coloring the building part, and
crack inhibitor for inhibiting a formation of cracks in the building part.

23. The printing system according to claim 16, further comprising:
a print head which is movable relative to the print bed, wherein the print head comprises the first discharge device and/or the second discharge device, or
a separate print head for each of the first and second discharge devices.

24. The printing system according to claim 16, further comprising:
a positioning device for controlled positioning of the first discharge device and/or the second discharge device relative to the print bed.

25. The printing system according to claim 17, wherein
wherein the movement unit comprises a controllable robot arm with a robot portion which is movable relative to the print bed in at least three degrees of freedom,
wherein the first discharge device and the second discharge device are arranged on the robot portion,
wherein the robot arm comprises a plurality of arm elements which are articulated relative to one another about associated axes of articulation and/or are rotatable transversely to the axes of articulation.

26. The printing system according to claim 16, wherein at least one of:
the second discharge device comprises a spraying device for discharging at least one functional material in the form of a spray jet, onto at least one layer of construction material,
the second discharge device comprises a foaming device for discharging at least one functional material in foam form, onto at least one layer of construction material,
the second discharge device comprises an application device for applying at least one functional material discharged via the second discharge device in the form of a spray jet, onto at least one layer of construction material.

27. The printing system according to claim 16, further comprising:
a pumping device for conveying at least one flowable functional material,
wherein the pumping device is fed from a supply of the flowable functional material, and the second discharge device is suppliable with the flowable functional material via the pumping device.

28. The printing system according to claim 16, further comprising:
a pneumatic, hydraulic and/or mechanical transport device for transporting at least one solid functional material,
wherein the transport device is fed from a supply of the solid functional material, and the second discharge device is suppliable with the solid functional material via the transport device.

29. The printing system according to claim 16, further comprising:
a connecting device,
wherein the connecting device is connected to the second discharge device, so that at least one functional material is fed to the second discharge device via the connecting device,
wherein the connecting device extends at least in certain regions along a robot arm of the printing system.

30. The printing system according to claim 16, further comprising:
a sensor device for monitoring a coating of at least one construction material layer with at least one functional material, and/or
a control unit set up to control an adjustment of the first discharge device and/or the second discharge device and to control the discharge of construction material and/or functional material.

31. The printing system according to claim 30, wherein
the control unit is connected to the sensor device in a data-transmitting manner.

32. A 3D printing method for automatically producing a building part via a printing system, the method comprising the steps of:
a) automatically arranging construction material in at least one construction material layer on a print bed, via a first discharge device that forms a strand of the construction material at a first discharge portion of the first discharge device, wherein the first discharge device is movable relative to the print bed in order to automatically arrange the construction material in the at least one construction material layer on the print bed; and
b) automatically coating at least one construction material layer with functional material, via a second discharge device that discharges the functional material, different from the construction material, at a second discharge portion of the second discharge device, wherein the second discharge device is movable relative to the print bed in order to automatically coat the at least one construction material layer, at least in portions, with the functional material.

33. The printing system according to claim 32, wherein the automatic coating is carried out in a strip-shape manner.

34. The printing system according to claim 32,
wherein, when step b) is carried out, a substantially horizontally oriented top side of at least one layer of construction material and/or at least one flank side of at least one layer of construction material which is oriented at an angle to the top side is coated with the functional material.

35. The printing system according to claim 32,
wherein step b) is carried out after step a), after arranging a predetermined number of construction material lawyers of the building part, or
wherein step b) is carried out in temporal overlap with step a), wherein the building material and the functional material are discharged with a local offset relative to one another.
